(19) United States
(12) Patent Application Publication
(10) Pub. No.: US 2009/0033475 A1
(43) Pub. Date: Feb. 5, 2009

(54) Bicycle Warning Device

(76) Inventors: Zbigniew Zuziak, Brookfield, IL (US); Bozena Lasota, Brookfield, IL (US)

Correspondence Address: FACTOR & LAKE, LTD, 1327 W. WASHINGTON BLVD., SUITE 5G/H, CHICAGO, IL, 60607, US

(21) Appl. No.: 12/182,830

(22) Filed: Jul. 30, 2008

Related U.S. Application Data
(60) Provisional application No. 60/962,541, filed on Jul. 30, 2007.

(51) Int. Cl. B62J 3/00

(52) U.S. Cl. 340/432

(57) ABSTRACT

A device for warning a bicycle rider of an object approaching the bicycle rider from behind a bicycle with a rear view mirror mounted to the bicycle by a mounting assembly, a detector mounted to the bicycle and capable of detecting the object and determining if the object is approaching the bicycle rider from behind the bicycle, and an alarm in electrical communication with the detector, the alarm mounted on one of the mirror or the mounting assembly.

### RELATED APPLICATIONS

The present invention claims priority to U.S. Provisional Application No. 60/965,541 filed on Jul. 30, 2007, the entire contents of which are herein incorporated by reference as if fully set forth herein.

### TECHNICAL FIELD

The present invention is directed to a warning device for a bicyclist. More specifically, the present invention is directed towards a warning device to be used by a bicyclist for detecting hazards approaching from behind the bicycle such as vehicles, other bicycles, roller skaters or joggers.

### BACKGROUND OF THE INVENTION

Despite different safety products for bikers designed for safety awareness while using roads or bike trails, there are still bicycle accidents occurring each year. Many of these accidents are not the fault of the bicycle riders. Products currently available to bicycle riders and the like, such as different bike accessories or bright-colored clothing, are not believed to be sufficient against traffic accidents because they fail to adequately identify and warn a bicycle user of a vehicle, other cyclist, a roller skater or a jogger approaching the user from behind.

In addition, due to low visibility during bad weather or even at different times on a sunny day, a bicyclist may not be able to see a vehicle, another bicyclist, a jogger or a roller skater approaching from behind the bicyclist.

Moreover, a bicyclist may be able to check the situation behind the bicycle by turning to look behind the bicycle or by looking into a rear view mirror. However, constantly looking back or into a mirror is believed to create a dangerous situation, possibly increasing the risk of an accident by diverting the cyclist's attention from the bicycle's direction of travel.

When a bicyclist does not know that another object is approaching the bicycle from behind, the bicyclist may not obey traffic rules and, instead, ride the bicycle inappropriately, not practicing safe cycling techniques. In such cases, as a result of an inappropriate manner of riding a bicycle, a bicycle user not only puts the user in a danger, but it is believed, the bicyclist also creates an accident threat for other people, for example, other bicyclists using the same roadway or path.

In addition, since the cyclist has to constantly look behind the bicycle or look into a rear view mirror in order to detect objects approaching the bicycle from behind, the cyclist cannot fully enjoy the ride.

It is believed that there is a greater threat of collisions on roads and bicycle trails when objects approaching from behind the cyclist try to pass the cyclist in a noiseless manner. This may occur without any warning signal to the cyclist or with a signal that is too late. In addition, if the cyclist decides to change lanes or turn, the probability of a collision with an approaching bicyclist or vehicle may increase especially on a bicycle trail because trails are usually more narrow in comparison to roads.

Furthermore, in some cases, a cyclist may get startled seeing another bicycle, vehicle, a roller skater or a jogger within a very close range from the bicyclist, making the situation dangerous for both.

### BRIEF SUMMARY OF THE INVENTION

In view of the above, in an embodiment, an object of the warning device described herein is to reduce the quantity of casualties between a bicyclist and others. This may be accomplished by warning the cyclist about objects approaching from behind and providing the cyclist with a safe time for cyclist to make a safe road maneuver, for example, to provide enough space to allow for the approaching object to safely pass the bicycle.

In addition, in an embodiment, a person (such as another bicycle rider or motor vehicle operator) approaching the bicycle rider from behind may be alerted by the optical signal or the acoustic signal, or both, which would allow the person an opportunity to slow down or change lanes if needed to safely pass the bicycle.

In an embodiment, use of the warning device as described herein may decrease the threat of collision in at least two ways: 1) by warning a cyclist with the acoustic signal or the optical signal, or both, about an object approaching from behind; and, 2) by sending the warning signal in the form of an acoustic signal or an optical signal, or both, to an approaching road user, altering the user of a cyclist situated in front of him.

In view of some of the above objects, a device for warning a bicycle rider of an object approaching the bicycle rider from behind a bicycle is disclosed herein. In an embodiment in accordance with the present invention, the device includes a rear view mirror mounted to the bicycle by a mounting assembly, a detector mounted to the bicycle and capable of detecting the object and determining if the object is approaching the bicycle rider from behind the bicycle, and an alarm in electrical communication with the detector, the alarm mounted on one of the mirror or the mounting assembly. The device may also include a movement circuit for determining if the bicycle has a movement, the detector and alarm being energized in response to the movement circuit. The device may provide an audio alert, a visual alert or both. Finally, the device may be disposed below a rack at a rear of the bicycle or above a tire at a rear of the bicycle.

In addition to the above, a method of warning a bicycle rider of an object approaching from behind a bicycle is also disclosed herein. In an embodiment in accordance with the present invention, the method may include the steps of transmitting at least one ultrasonic wave, receiving at least one first ultrasonic echo from at least one object behind the bicycle, determining a first time value for the first ultrasonic echo, storing the first time value in a memory, transmitting at least one second ultrasonic wave, receiving at least one second ultrasonic echo from the at least one object behind the bicycle, determining a second time value for the second ultrasonic echo, comparing the second time value with the first time value, and, warning the bicycle rider if the second time value is less than the first time value. The method may also include the first and second ultrasonic waves contained in an ultrasonic energy beam pattern, and, the first and second echoes are received from a plurality of objects in the beam pattern. Alternatively, the method may also include that the first and second echoes are received from all objects in the beam pattern. In addition the method may also include the steps of mounting a transmitter and a receiver on a rear portion of the bicycle, wherein the transmitter transmits the first and second ultrasonic waves and the receiver receives the first and second ultrasonic echoes. The transmitter and receiver may be mounted below a rack at the rear portion the bicycle or above a rear tire on the rear portion of the bicycle. Finally, the method may also include the step of determining if there is a movement of the bicycle before the step of transmitting at least one ultrasonic wave.

In accordance with the present invention, and also in addition to the above, another method of warning a bicycle rider of an object approaching the bicycle rider from behind a bicycle is disclosed herein. The method may include the steps of transmitting an ultrasonic wave, receiving a plurality of ultrasonic echoes from a plurality of objects behind the bicycle, determining a time value for each of the ultrasonic echoes, comparing the time values with stored time values for echoes relative to the objects causing the echoes, and, warning the bicycle rider if the step of comparing each ultrasonic echo determines that any object from the plurality of objects is approaching the bicycle rider. This method may further include a rear view mirror mounted to the bicycle by a mounting assembly and wherein the step of warning the bicycle rider is performed by an alarm mounted on one of the mirror or the mounting assembly. Again, the alarm may be an audio alarm, a visual alarm, or both. Finally, this method may also include the step of conserving energy by determining if the bicycle is moving and transmitting the ultrasonic signal only when the bicycle is moving.

One advantage of one or more embodiments of the present invention is provided by an alarm system mounted on the bicycle's rear view mirror (or the mirror's mounting assembly). When the alarm goes off (either a visual or audio or both), the cyclist, in addition to being alerted, will not have to glace behind the bicycle, to view the approaching objects. Rather, since the alarm will capture the rider's attention, the rider will most likely look at the mirror (and the alarm), it would be advantageous to mount the alarm on the mirror (or the mirror mounting assembly) so as to allow the cyclist to easily view behind the bicycle when objects are detected as approaching.

Another advantage of one or more of the embodiments of the present invention is that the bicycle rider is only alerted of vehicles that are approaching the bicycle rider from behind the bicycle. This is advantageous because the invention does not warn the rider every time an object is detected behind the rider, but rather, only objects that are detected and determined to be approaching. This is believed to minimize distractions to the bicycle rider and allow the rider to concentrate and enjoy the bicycle ride.

Other embodiments, systems, methods, features, and advantages of the present invention will be, or will become, apparent to one having ordinary skill in the art upon examination of the following drawings and detailed description. It is intended that all such additional systems, methods, features, and advantages included within this description will be within the scope of the present invention, and can be protected by the accompanying claims.

### BRIEF DESCRIPTION OF THE DRAWINGS

The invention may be better understood with reference to the following drawings. The components in the drawings are not necessarily to scale, emphasis instead being placed upon illustrating the principles of the invention. In the drawings, like reference numbers designate corresponding parts throughout.

FIG. 1 is a block diagram of an embodiment of a detector for a bicycle warning device in accordance with the present invention.

FIG. 2 is a side view with an embodiment of a bicycle warning device according to the present invention.

FIG. 3 is a side view of another embodiment of a bicycle warning device according to the present invention.

FIG. 4 is front perspective view of bicycle handlebars with a mirror and a alarm according to an embodiment of the present invention.

### DETAILED DESCRIPTION

The following descriptions of detailed embodiments are for exemplifying the principles and advantages of the inventions claimed herein. They are not to be taken in any way as limitations on the scope of the inventions.

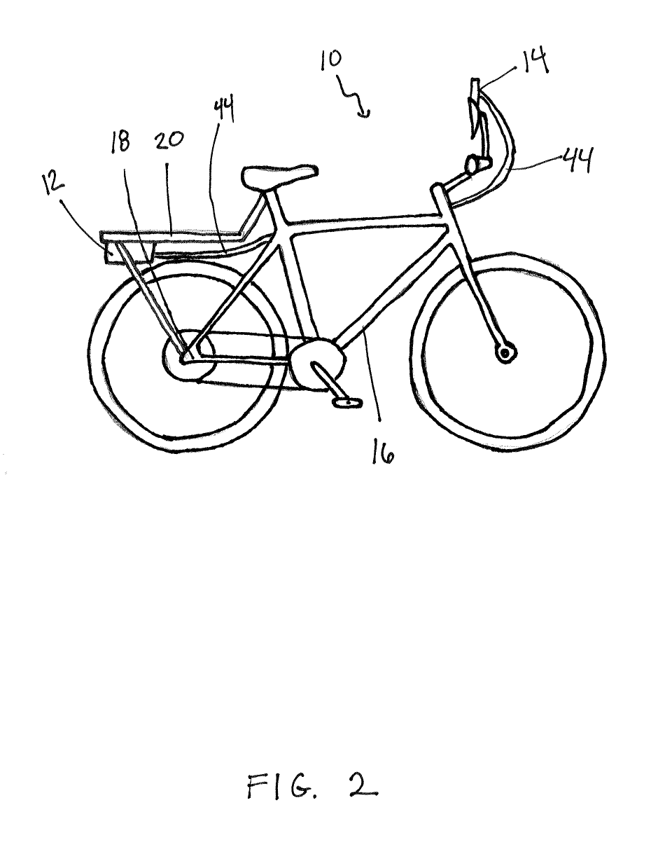

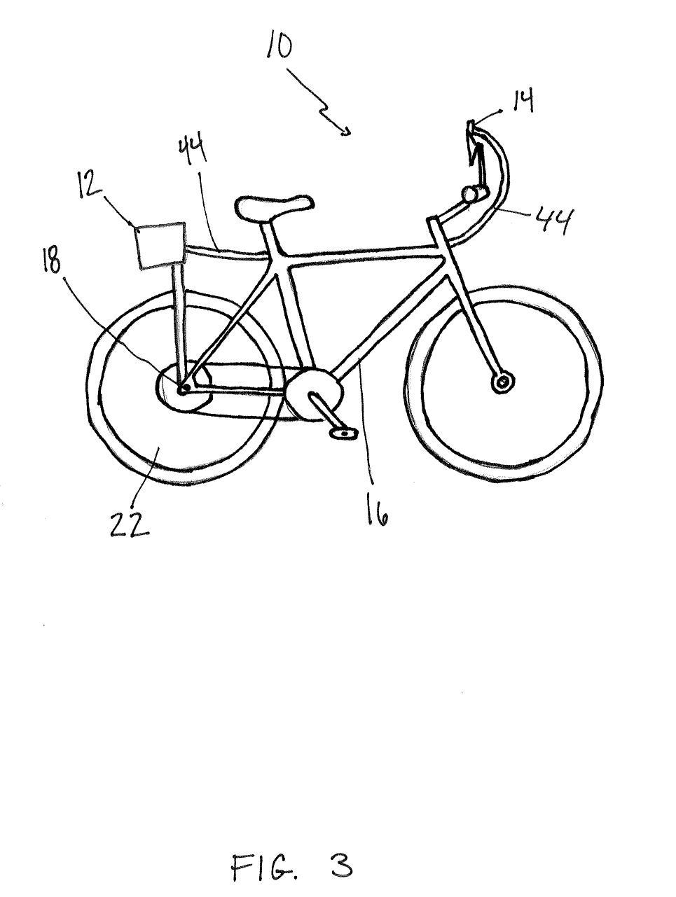

According to an embodiment of the present invention, a bicycle warning device 10 includes a detector 12 and an alarm 14. The detector 12 is mounted on a bicycle 16, and more specifically, on a rear portion 18 of the bicycle 16. In one embodiment, shown in FIG. 2, the detector 12 is mounted, or disposed, below a rack 20 on the rear portion 18 bicycle 16. In another embodiment, shown in FIG. 3, the detector 12 is mounted, or disposed, above a rear tire 22 on the rear portion 18 of the bicycle 16. The detector 12 is in electrical communication with the alarm 14, by, for example, a wire 44.

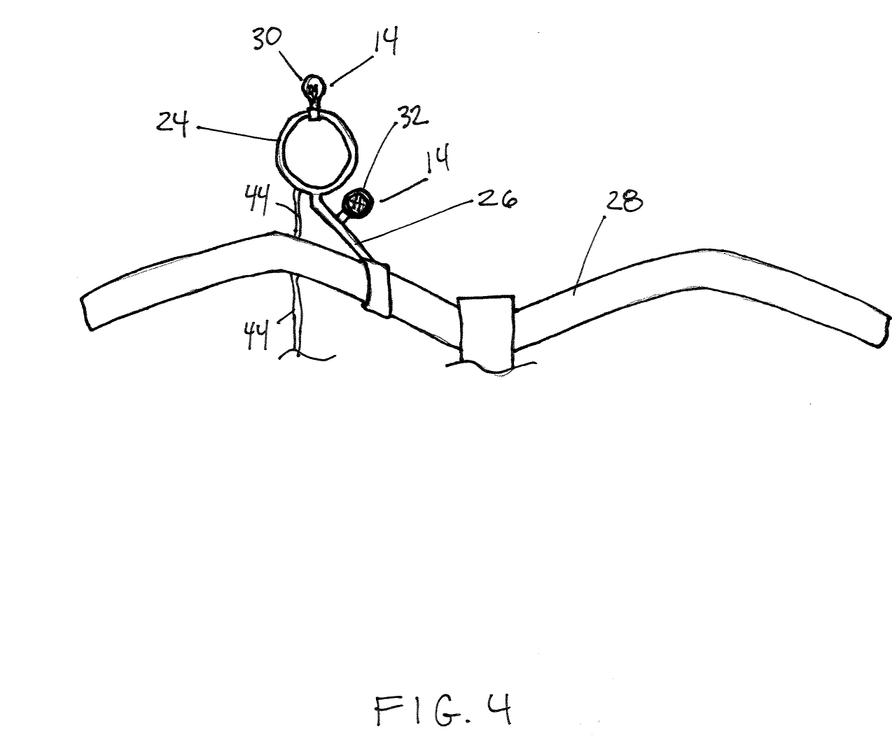

As shown in FIG. 4, the alarm 14 is mounted on a rear view mirror 24 or on a mounting assembly 26 of the mirror 24, which can be used to mount the rear view mirror 24 on handlebars 28 of the bicycle 16. The alarm 14 may produce a visual alert, or alarm, such as by utilizing a light 30, LED or similar component. The alarm 14 may also produce an audio alert, or alarm, such as by utilizing a speaker 32 or other similar component. It is contemplated that the alarm 14 produce both an audio alert and a visual alert, and, for example, that both a light 30 and a speaker 32 be utilized.

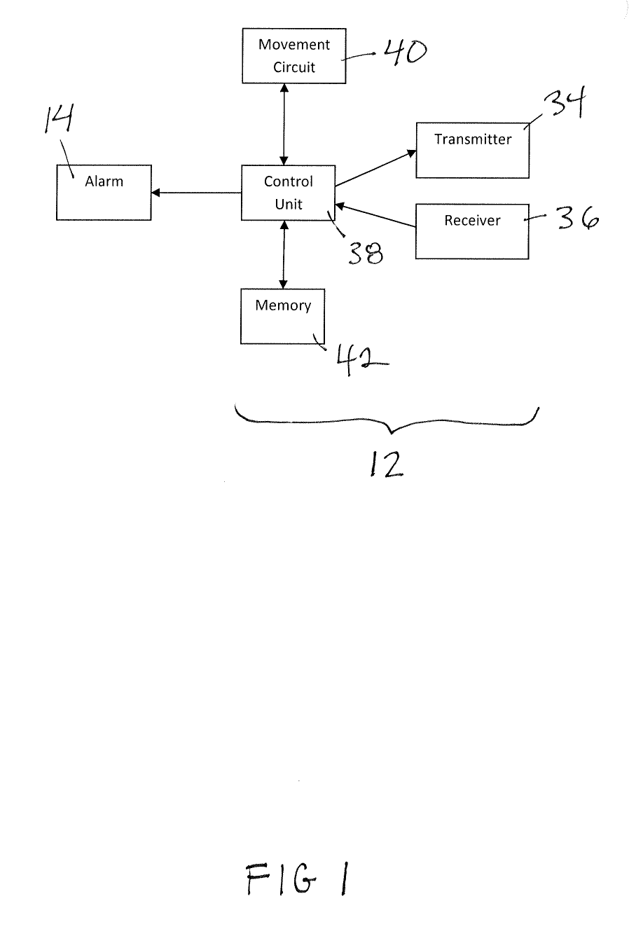

Turning to FIG. 1, an embodiment of a detector 12 according to the present invention is generally shown and is capable of detecting the object and determining if the object is approaching the bicycle rider from behind the bicycle. The detector may include a transmitter 34, a receiver 36, a control unit 38, a movement circuit 40, a memory 42 and a power source (not shown).

The transmitter 34 is capable of transmitting an ultrasonic wave. The ultrasonic wave may be transmitted in a beam pattern. The receiver 36 is capable of detecting echoes, or return signals, from objects.

The movement circuit 40 may be utilized to conserve electrical energy. The movement circuit 40 may comprise any known devices for detecting or determining if the bicycle 16 is moving, including, but not limited to motion sensors. If the bicycle 16 is not moving, the power source does not provide electrical energy to the bicycle warning device 10. This would allow for the conservation of electrical energy as the bicycle warning device 10 would only operate when the bicycle 16 is in motion.

The control unit 38 communicates with the transmitter 34 and receiver 36. The control unit 38 sends a signal to the transmitter 34 to transmit an ultrasonic wave. When the receiver 36 detects an echo from an object, the control unit 38 calculates a time value for the echo of that object. The control unit is also in communication with the memory 42 and the time value for the echo (or echoes) is stored in the memory 42. When the receiver 36 receives a second echo from an object (corresponding to a second ultrasonic wave), the control unit 38 calculates a time value for the echo of the object and compares it to the time value stored in the memory 42. If the control unit 38 determines that the second time value of an echo of an object is smaller than the first time value for an echo of the same object, the control unit 38 alerts, or warns, the bicycle rider by sending a signal to operate the alarm 14.

Since it is contemplated that more than one object will be detected, the control unit 38 can differentiate the different echoes for the different objects and determine the difference in the first and second time values for all of the objects. In addition, the control unit 38 may be programmed to ignore time values over a certain value because the object corresponding to the echo may be at a safe enough distance away.

Using the memory system 42 avoids instances of false alarms, for example when the bicycle rider passes a stationary object, such as a parked car. Since the second time value will be greater for the stationary object, the bicycle rider will not be alerted by the mere presence of an object behind the bicycle 16. Rather, the memory 42 allows for the bicycle rider to be alerted only when an object is approaching the bicycle rider from behind the bicycle 16.

In addition to warning the bicycle rider, the alarm 14 may also warn or alert an approaching vehicle user or bicycle rider to the presence of the bicycle 16.

It should be emphasized that the above-described embodiments of the present invention, particularly, any “preferred” embodiments, are possible examples of implementations merely set forth for a clear understanding of the principles for the invention. Many variations and modifications may be made to the above-described embodiment(s) of the invention without substantially departing from the spirit and principles of the invention. All such modifications are intended to be included herein within the scope of this disclosure of the present invention, and protected by the following claims.

What is claimed is:

1. A method of warning a bicycle rider of an object approaching from behind a bicycle, the method comprising the steps of:
transmitting at least one ultrasonic wave;
receiving at least one first ultrasonic echo from at least one object behind the bicycle;
determining a first time value for the first ultrasonic echo;
storing the first time value in a memory;
transmitting at least one second ultrasonic wave;
receiving at least one second ultrasonic echo from the at least one object behind the bicycle;
determining a second time value for the second ultrasonic echo;
comparing the second time value with the first time value; and,
warning the bicycle rider if the second time value is less than the first time value.

2. The method of claim 1 wherein:
the first and second ultrasonic waves are each contained in an ultrasonic energy beam pattern; and,
the first and second echoes are received from a plurality of objects in the beam pattern.

3. The method of claim 2 wherein:
the first and second echoes are received from all objects in the beam pattern.

4. The method of claim 1 further comprising the first step of:
mounting a transmitter and a receiver on a rear portion of the bicycle, wherein the transmitter transmits the first and second ultrasonic waves and the receiver receives the first and second ultrasonic echoes.

5. The method of claim 4 wherein the transmitter and receiver are mounted below a rack at the rear portion the bicycle.

6. The method of claim 4 wherein the transmitter and receiver are mounted above a rear tire on the rear portion of the bicycle.

7. The method of claim 1 further comprising the steps of:
determining if there is a movement of the bicycle before the step of transmitting at least one ultrasonic wave.

8. A device for warning a bicycle rider of an object approaching the bicycle rider from behind a bicycle, the device comprising:
a rear view mirror mounted to the bicycle by a mounting assembly;
a detector mounted to the bicycle and being capable of detecting the object and determining if the object is approaching the bicycle rider from behind the bicycle; and,
an alarm in electrical communication with the detector, the alarm being mounted on one of the mirror or the mounting assembly.

9. The device of claim 8 further comprising:
a movement circuit for determining if the bicycle has a movement, the detector and alarm being energized in response to the movement circuit.

10. The device of claim 8 where the detector is disposed below a rack at a rear of the bicycle.

11. The device of claim 8 where the detector is disposed above a tire at a rear of the bicycle.

12. The device of claim 8 wherein the alarm provides an audio alert.

13. The device of claim 8 wherein the alarm provides a visual alert.

14. The device of claim 8 wherein the alarm provides an audio alert and a visual alert.

15. A method of warning a bicycle rider of an object approaching the bicycle rider from behind a bicycle, the method comprising the steps of:
transmitting an ultrasonic wave;
receiving a plurality of ultrasonic echoes from a plurality of objects behind the bicycle;
determining a time value for each of the ultrasonic echoes;
comparing the time values with stored time values for echoes relative to the objects causing the echoes; and,
warning the bicycle rider if the step of comparing each ultrasonic echo determines that any object from the plurality of objects is approaching the bicycle rider.

16. The method of claim 15 wherein the bicycle includes a rear view mirror mounted to the bicycle by a mounting assembly and wherein the step of warning the bicycle rider is performed by an alarm mounted on one of the mirror or the mounting assembly.

17. The method of claim 16 wherein the alarm is an audio alarm.

18. The method of claim 16 wherein the alarm is a visual alarm.

19. The method of claim 16 wherein the alarm is both an audio alarm and a visual alarm.

20. The method of claim 15 further comprising the step of:
conserving energy by determining if the bicycle is moving and transmitting the ultrasonic signal only when the bicycle is moving.
